(19) United States
(12) Patent Application Publication
(10) Pub. No.: US 2020/0168974 A1
(43) Pub. Date: May 28, 2020

(54) TRANSITION ARRANGEMENT, A TRANSITION STRUCTURE, AND AN INTEGRATED PACKAGED STRUCTURE

(71) Applicant: Gapwaves AB, Göteborg (SE)

(72) Inventor: Abbas VOSOOGH, Göteborg (SE)

(73) Assignee: Gapwaves AB, Göteborg (SE)

(21) Appl. No.: 16/631,855

(22) PCT Filed: Jul. 25, 2017
(86) PCT No.: PCT/SE2017/050793

§ 371 Date: Jan. 17, 2020

(51) Int. Cl. H01P 5/107; H01P 1/20; H01Q 21/06

(52) U.S. Cl. CPC H01P 5/107; H01P 5/028; H01Q 21/064; H01P 1/2005

(57) ABSTRACT

A transition arrangement including a first transmission line being a planar transmission line including a coupling section and being disposed on a dielectric substrate layer. The substrate layer has a periodic or quasi-periodic structure arranged in the substrate layer such as to be disposed along at least part of the first transmission line and to partly surround the coupling section. The transition arrangement includes a conducting layer on which the substrate layer is arranged and which is adapted to act as a ground plane, and the periodic or quasi-periodic structure is so arranged and at such a distance from the first transmission line and/or the coupling section that EM energy, RF power, can be coupled contactlessly between the first transmission line and the periodic or quasi-periodic structure, the transition between the first transmission line and the periodic or quasi-periodic structure being planar and contactless without any galvanic contact.

### TECHNICAL FIELD

The present invention relates to a transition arrangement for providing at least one transition between a planar transmission line and a waveguide having the features of the first part of claim 1. The invention also relates to a transition structure comprising such a transition having the features of the pre-characterizing part of claim 14.

The invention also relates to an integrated packaging structure comprising a circuit arrangement and an antenna arrangement having the features of the first part of claim 29.

### BACKGROUND

The use of high frequencies, in the millimetre-wave and sub-millimetre-wave frequency bands, is receiving more and more attention for many different applications, for example high data rate communication links and automotive radar applications. It is attractive to be able to use these frequency regions due to the availability of larger frequency bandwidths. Therefore transitions, or interconnects, between transmission lines, circuits and waveguides or antennas are needed for many different purposes and applications. However, several problems are associated with the provisioning of such transitions or interfaces and, e.g. in particular for antenna and passive and active components integration. A good electrical performance, mechanical reliability and low costs are crucial for high frequency applications, as well as compactness.

In U.S. Pat. No. 8,680,936 a surface mountable transition block for perpendicular transitions between a microstrip or stripline and a waveguide is proposed. A disadvantage of this transition arrangement is that it is not as compact as would be needed for several applications, such as for a steerable beam array antenna with several connected antennas and Tx/Rx blocks. Furthermore, the structure is relatively complex and a very good electrical contact is required by means of via holes for connection with metal planes.

U.S. Pat. No. 7,486,156 discloses a microstrip-waveguide transition arrangement which is fed from the side. Also, this arrangement has a complex structure and is not as compact as would be desired.

In Seo, K., “Planar microstrip-to-waveguide transition in millimetre-wave band”, http://dx.doi.org/10.5772/54662, Advancement in Microstrip Antennas with Recent Applications, Chapter: Chapter 11, Publisher: INTECH, Editors: Ahmed Kishk, pp. 249-277, 2013-03-06 different types of transitions between waveguides and microstrip lines are discussed, such as a probe transition with a back-short, planar proximity coupling transition, a broadband technique of the proximity coupling type transition and a narrow-wall-connected microstrip-to-waveguide transition.

However, all these transitions leave a lot to desire as far as simplicity in structure and compactness etc. is concerned, and several problems associated with the provisioning of a transition between a transmission line and a waveguide remain to be solved, and, so far, no solutions which are entirely satisfactory have been suggested, and all so far proposed transitions between transmission lines and waveguides suffer from disadvantages limiting their use.

Furthermore, for a transition between a waveguide and a circuit at high frequencies, a separate E-plane probe transition is used to provide the interface between the waveguide and the circuit. The E-plane probe transition converts the waveguide TE₁₀ mode to a microstrip or coplanar mode, and a separate transition requires a bond-wire or a flip-chip connection.

The use of separate E-plane probe transitions further complicates any packaging process since they require back-shorts and further steps associated with mounting and accurate alignment of the transition circuit with respect to e.g. a circuit, such as for example an RFIC (Radio Frequency Integrated Circuit) or an MIMIC (Monolithic Microwave Integrated Circuit).

Attempts to integrate waveguide transitions onto a circuit (e.g. an MMIC) for a steerable beam array antenna where many antenna elements need to connect to a separate RF chain generally have not been successful. The main reason is that the width of whole the waveguide transition is way more than λ/2 while the antenna element spacing needs to be below λ/2 to avoid high grating lobes.

In A. U. Zaman, M. Alexanderson, T. Vukusic and P. S. Kildal, “Gap Waveguide PMC Packaging for Improved Isolation of Circuit Components in High-Frequency Microwave Modules,” in IEEE Transactions on Components, Packaging and Manufacturing Technology, vol. 4, no. 1, pp. 16-25, January 2014, is disclosed that the use of gap waveguide technology is an effective packaging technique for mm Wave systems that exhibits a lower insertion loss compared to conventional packaging techniques. The circuits are packaged with a pin metal lid, or bed of nails, which works as a high impedance surface or an AMC (Artificial Magnetic Conductive) surface in a wide frequency range. The resulting PEC-PMC (Perfect Electric Conductor-Perfect Magnetic Conductor) parallel-plate waveguide creates a cut-off for the electromagnetic waves, in such a way that the unwanted packaging problems due to substrate modes and cavity resonances are suppressed.

### SUMMARY

It is therefore an object, in the most general aspect of the present invention, to provide a transition arrangement as initially referred to which can be used e.g. for interconnection of any planar transmission line, e.g. a microstrip line, a stripline or a coplanar transmission line, with a second transmission line, e.g. a waveguide, through which one or more of the above mentioned problems are overcome.

Particularly it is an object of the present invention to provide a transition arrangement, most particularly a high frequency transition arrangement, which is compact.

It is a particular object to provide a transition arrangement, even more particularly a high frequency transition arrangement, which has a simple structure, which is cheap and easy to fabricate, particularly suitable for mass fabrication, and which is easy to assemble.

Particularly it is also an object to provide a transition arrangement, most particularly a high frequency transition arrangement, with a good electrical performance and which has a good mechanical reliability.

Another particular object is to provide a transition arrangement, most particularly a high frequency transition arrangement, which is frequency scalable, and particularly which can be used for different frequencies, from very low frequencies up to very high frequencies, or for microwaves up to sub-millimetre waves.

Further yet it is a particular object to provide a high frequency transition arrangement which can be used for high frequencies, e.g. above 67 GHz or considerably higher, but also a transition arrangement suitable for lower frequencies.

Therefore a transition arrangement as initially referred to is provided which has the characterizing features of claim 1.

It is also an object is to provide a transition structure comprising a transition between a planar transmission line and a second transmission line comprising a waveguide as initially referred to through which one or more of the aforementioned problems can be solved, and which particularly is compact and easy to assemble.

Therefore a transition structure as initially referred to is provided which has the characterizing features of claim 14.

It is also an object of the present invention to provide an integrated packaged or packaging structure comprising an antenna having the features of the first part of claim 29 with one or more transition arrangements or transition structures as referred to above which is easy to fabricate, which is compact and which allows assembly in a fast and easy manner, and which particularly also can be disassembled.

It is also an object to provide a packaged structure, or a packaging structure, comprising one or more such transitions which has low insertion losses, low or substantially no leakage, and is flexible in use.

Further a particular object is to provide a highly integrated structure comprising one or more such transitions which is easy to fabricate, to mount or assemble and which can find a wide-spread use for interconnection of active or passive components and antennas.

Yet another object to is provide a packaged structure, or a packaging structure, comprising one or more such transitions between antennas and active and/or passive components which has a high efficiency and performance, a high gain despite a narrow bandwidth.

Particularly it is an object to provide a packaged structure, or a packaging structure, comprising an antenna arrangement with a good electrical performance and which has a good mechanical reliability.

It is also a particular object to provide a high frequency integrated packaged structure, or packaging structure, which can be used for high frequencies, e.g. above 67 GHz or considerably higher, but also for lower frequencies without leakage of undesired waveguide modes into one or more circuit arrangement arranged on a chip, e.g. an RFIC or an MMIC and between planar transmission lines and waveguides, and which allows a very good coupling of energy to one or more antennas of the packaging structure antenna.

It is also an object to provide a packaging structure with a transition arrangement which is reliable and precise in operation.

Still further a particular object is to provide a packaging structure comprising one or more transitions or interconnects between active and/or passive components, or a circuit arrangement, e.g. one or more RFICs, MMICs, and an antenna arrangement comprising one or more radiating elements through which one or more of the above mentioned problems can be overcome, and which is among other things is easy to fabricate, easy to assemble, preferably also to disassemble, and which is compact, is wideband, has a high performance and low losses.

It is also an object is to provide an integrated packaged structure comprising an antenna arrangement which is steerable, with a steerable beam, particularly with a high gain and a narrow beam, and which is compact.

Therefore an integrated packaged or packaging structure as initially referred to is provided which has the characterizing features of claim 29.

Advantageous embodiments are given by the respective appended dependent claims.

It is an advantage that a packaging structure is provided which has a simple structure and which can be used for many different applications and purposes.

It is an advantage of the invention that a (high) frequency transition arrangement which is compact is provided without the need of having electrical contact between waveguide part and planar transmission line, e.g. a microstrip line.

It is an advantage of the invention that a (high) frequency transition arrangement which is compact is provided which has a wide bandwidth without the need of having a back-short, still having a wide frequency response.

It is also an advantage that a transition arrangement which has a simple structure is provided, which is cheap and easy to fabricate, suitable for mass fabrication, and which is easy to assemble, particularly since no electrical contact is required.

A particular advantage of the invention is that a compact transition arrangement is provided which has a simple structure wherein electrical and galvanic contact between waveguide and e.g. RF board is not needed and which can be widely used.

It is also an advantage that a transition structure is provided which is compact, contactless, and which does not require any back-short. It is also an advantage that a structure is provided which is a multilayer structure. Another advantage is that an integrated and packaged structure is provided which is compact, which can comprise a large number of radiating elements, has low losses, a high yield, is frequency scalable, and is easy to assemble.

It is further an advantage that an integrated packaged structure comprising an antenna arrangement is provided which is easy to fabricate, which is compact and which allows assembly in a fast and easy manner, without any electrical contact requirement between the building blocks, and which particularly also can be disassembled.

It is an advantage of the inventive concept that interconnection problems associated with interconnection of planar transmission lines and waveguides, circuit arrangements and other circuit arrangements and with interconnection with e.g. antennas are overcome.

### BRIEF DESCRIPTION OF THE DRAWINGS

The invention will in the following be further described in a non-limiting manner, and with reference to the accompanying drawings, in which:

FIG. 1 is a view in perspective of a first embodiment of a transition arrangement,

FIG. 2 is a view in perspective of a second embodiment of a transition arrangement comprising additional longitudinal rows of mushrooms,

FIG. 3 is a view in perspective of a transition arrangement according to a third embodiment, comprising only one transversal row of mushrooms,

FIG. 4 is a view in perspective of a transition structure comprising a transition to a double ridged waveguide in a non-assembled state,

FIG. 5 is a view in perspective of the transition structure as shown in FIG. 4 comprising a transition to a double ridged waveguide in an assembled state,

FIG. 5A is a cross-sectional view taken longitudinally through the central portion of the transition structure of FIG. 5 in perspective,

FIG. 6 is a view in perspective of the planar transition part of the transition structure of FIG. 4 with the dielectric substrate shown as transparent,

FIG. 7 is a schematic top view of the transition structure of FIG. 5,

FIG. 8 is a view in perspective of a transition structure comprising a transition to a single ridged waveguide in an assembled state,

FIG. 9 is a schematic top view of the transition structure of FIG. 8,

FIG. 10 is a view in perspective of a transition structure comprising a transition to a single ridged waveguide in an assembled state according to another embodiment,

FIG. 11 is a schematic top view of the transition structure of FIG. 10,

FIG. 12 is a view in perspective of a transition structure comprising a transition to a rectangular waveguide in an assembled state,

FIG. 13 is a top view of the transition structure shown in FIG. 12,

FIG. 14 is an exploded view of the transition structure in FIG. 4 with all the layers disassembled,

FIG. 15 is a view in perspective of a transition structure comprising two transitions, each to a respective rectangular waveguide, in a partly is-assembled state,

FIG. 16 is a view in perspective of a multilayer integrated array antenna and chip structure comprising an antenna arrangement and a number of microstrip-to-waveguide transitions in a state for assembly,

FIG. 17 is a view of in perspective of the lower side of the top, antenna or slot, layer of the integrated structure shown in FIG. 16,

FIG. 18 is a view of in perspective of the lower side of the feeding or transition layer facing the circuit or substrate layer of the integrated structure shown in FIG. 16, and

FIG. 19 is a view of in perspective of the bottom, circuit or substrate, layer of the integrated structure shown in FIG. 16.

### DETAILED DESCRIPTION

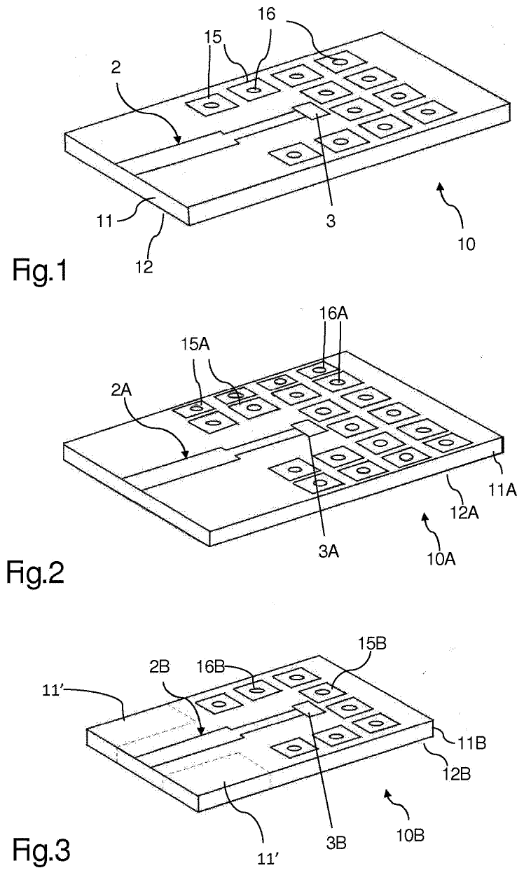

FIG. 1 schematically illustrates a transition arrangement 10 according to a first embodiment of the invention which comprises a transition between a first transmission line being a microstrip line 2, or alternatively a CPW (coplanar waveguide) or similar, with a coupling section 3 arranged on a substrate 11, e.g. a dielectric substrate. The area around coupling section 3 in substrate 11 is adapted to comprise or act as an EBG (Electronic Band Gap) structure or any other appropriate periodic structure, e.g. as described in D. Sievenpiper, L. Zhang, R. F. Jimenez Broas, N G. Alexopolous, and E. Yablonovitch, “High-impedance electromagnetic surfaces with a forbidden frequency band ides”, IEEE Transactions on Microwave Theory and Techniques, Vol. 47, No 11, . . . pp. 2059-2074, November 1999.

In advantageous embodiments the periodic structure is etched in the substrate 11, and it here comprises a plurality of mushrooms 15,15 . . . arranged in transversal and longitudinal rows disposed perpendicularly to and in parallel with the microstrip 2 and disposed on three sides of the coupling section 3 and along part of the two length sides of the microstrip line 2. For definition, some of the mushrooms can be said to form part of both a transversal and of a longitudinal row.

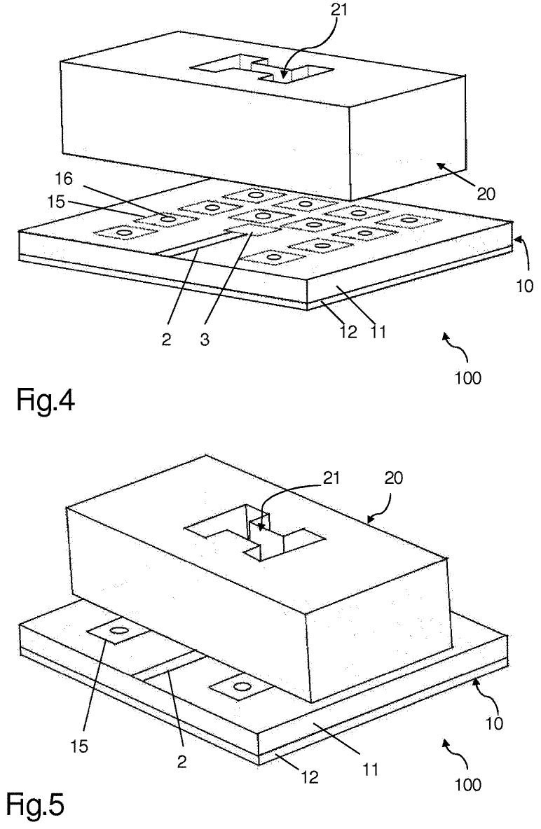

The substrate layer 11 is disposed on a conducting layer 12 forming a ground plane. Through the use of the periodic structure, here formed by the mushrooms, the transition is allowed to be contactless since the periodic structure stops waves propagating in non-desired directions. Since there will be a strong coupling between the coupling section 3 of the microstrip line 2 and the mushrooms 15, the need for any backshort is avoided which is extremely advantageous. Via the coupling section 3 the EM (electro-magnetic) field from the microstrip line 2 via the mushrooms 15 can be coupled to a second transmission line e.g. a waveguide (see for example the transition structures in FIG. 4 ff.), and all RF (Radio Frequency) power is delivered from the microstrip input to the coupling section 3. The coupling section 3 may e.g. be a waveguide or a second microstrip line.

Through the use of e.g. an EBG structure leakage can be avoided completely or to a large extent without there being any contact, and no back-short is needed as mentioned above while there is still a wide band frequency response, and, in addition, an easy assembly of a transition structure providing a transition to a waveguide, waveguides of different types, can be provided. The substrate may also comprise a high impedance surface of any other kind or e.g. an AMC surface, e.g. comprising a periodic or a quasi-periodic structure.

The structure is planar and contactless which is extremely advantageous, allowing the forming of multilayer structures.

In the shown embodiment there are two transversal rows of each four mushrooms 15, . . . which are disposed beyond the coupling section 3 and two longitudinal rows, one on either side of the microstrip 2, each longitudinal row with four mushrooms (two of which also forming part of the two transversal rows disposed beyond the coupling section 3). In the shown embodiment the mushrooms 15 are square shaped with small vias 16 for connection with the ground plane 12. It should however be clear that the mushrooms may have any appropriate shape, circular, rectangular, oval etc., or even in some embodiments they may comprise ridges or similar, or more generally that any other appropriate periodic or quasi-periodic, preferably etched, structure may be used. Also the number of mushrooms, their disposition in regular or partially irregular patterns may vary.

The perpendicular distance between the coupling section 3 of the microstrip line 2 and the first transversal row of mushrooms 15 depends on the used operating frequency, or the wavelength, but is for example about 500 μm, and the distance between adjacent mushrooms is about 700 μm for an operating frequency of about 30 GHz. It should be clear that these figures are by no means to be taken in a limitative sense, but the distances are frequency/wavelength dependent, and can also be different for a given frequency/wavelength in different implementations. Thus, the transition is scalable, and the distances may be larger as well as smaller. For example to operate at 60 GHz, the dimensions and distances of the structure, or the structure, can be scaled by factor of 0.5. the scalability for the dimensions of the structure is substantially linear. If all dimensions and distances are scaled by a factor two, or doubled, the operation frequency band, or the frequencies thereof, will be halved.

The transition arrangement technically can be used for substantially any operation frequency, e.g. from about 1, 2 or 3 GHz up to e.g. 300 GHz, within microwave and millimetre frequency bands.

The disposition and the number of e.g. rows of, here, mushrooms depend on to what type of waveguide there should be a transition. In particular, the second row in the longitudinal direction of the microstrip line 2 distant from the coupling section 3 might be disposed of, particularly, but not exclusively, for perpendicular transitions to waveguides with a relatively narrow aperture, such as a double ridged waveguide. Such additional distant rows assist in providing a better performance.

For example, for a transition to a rectangular waveguide it is advantageous if there are more mushrooms, or protruding elements or similar, since the opening aperture is larger. Particularly there may be three or more rows on either side along the microstrip line for a transition to a rectangular waveguide.

FIG. 2 shows a transition arrangement 10A similar to the transition arrangement 10 of FIG. 1 with the difference that two additional longitudinal rows of mushrooms 15A,15A, . . . are provided which are located in parallel to and external of each respective longitudinal row as in FIG. 1, which is just another example of a transition arrangement which is advantageous for connections or transitions to waveguides with a wider aperture such as e.g. a rectangular waveguide as referred to above. It may of course also be used for transitions to other waveguides, e.g. double ridged waveguides, single ridged waveguides, circular waveguides etc. As referred to above there may also be one or more additional transversal rows of mushrooms, particularly for enhancing the performance. The same reference numerals as in FIG. 1 but indexed “A” are used for corresponding elements and the elements will therefore not be further explained here.

FIG. 3 shows a transition arrangement 10B similar to the transition arrangement 10 of FIG. 1 but with the difference that there is only one transversal row of mushrooms 15B, which is just another example of a transition arrangement which also can be used, particularly in cases when the requirements on performance are not so high or critical. It may be used for transitions to different types of waveguides, e.g. double ridged waveguides, single ridged waveguides, circular waveguides etc. In still other embodiments there may be one or more additional longitudinal rows of mushrooms, e.g. particularly for waveguides with broader apertures, such as rectangular waveguides. The dashed lines indicate sections 11′,11′ of the substrate and the ground plane that could be disposed of and which are not necessary for the functioning of the inventive concept. This is also applicable for other implementations of a transition arrangement, e.g. as disclosed in FIG. 1 and FIG. 2 or any other alternative implementation. The same reference numerals as in FIG. 1 but indexed “B” are used for corresponding elements and will therefore not be further explained here. FIG. 4 shows a transition structure 100 comprising a transition arrangement 10 as in FIG. 1, also denoted a planar transition part, and a waveguide block 20, e.g. of solid metal or with a metalized surface, here comprising a double ridged waveguide 21, in a non-assembled state.

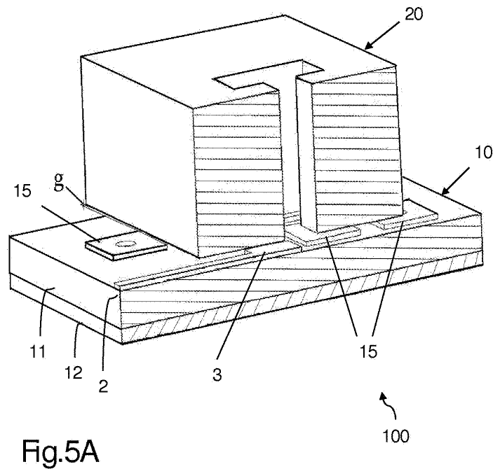

FIG. 5 shows the transition structure 100 of FIG. 4 in an assembled state wherein the waveguide block 20 is disposed on the transition arrangement 10 such that the double ridged waveguide 21 will be located above the coupling section 3 and such that there is slight a gap there between, the width of the gap being approximately between 0 to 0.03λ (0-300 μm at 30 GHz). In this embodiment the waveguide block 20 covers the mushrooms 15 except for two mushrooms 15 located in each a longitudinal row and which are most distant with respect to the coupling section (not visible in FIG. 5) and the distant transversal row of mushrooms (not visible in FIG. 5). Due to the EBG structure (or any other appropriate periodic or quasi-periodic structure), which here is formed by longitudinal and transversal rows of mushrooms 15,15, . . . and which stops propagation of waves a contactless transition can be provided which is extremely advantageous, and a perpendicular microstrip-to-waveguide transition is provided which is very easy to fabricate and to assemble which also is very compact. The transition is contactless, without any galvanic contact between the first transmission line, the coupling section 3 of the microstrip 2, and the mushrooms 15, . . . and between the mushrooms 15, . . . and the double ridged waveguide 21 (gap gin FIG. 5A), and an excellent coupling of energy is provided.

Alignment means (not shown) of any desired type may be used for assuring an appropriate alignment between the waveguide part 20 and the transition arrangement 10.

FIG. 5A is a cross-sectional view taken through the central portion of the transition structure 100 longitudinally through the central part of the microstrip 2, the coupling section 3 and the waveguide block 20 with the double-ridged waveguide, also indicating the gap g there between. The same reference numerals as in FIG. 5 are used for corresponding elements and they will therefore not be further explained here.

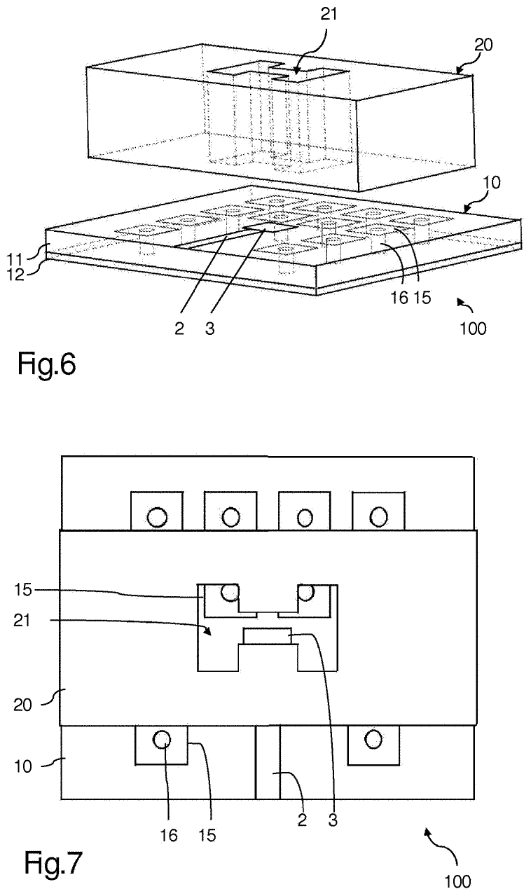

FIG. 6 is a view in perspective of the transition structure 100 similar to FIG. 4, but wherein dashed lines are used to illustrate the extension of the double ridged waveguide 21 and the vias 16 through the substrate layer 11 connecting the heads of the mushrooms 15 etched in the substrate 11 with the conducting layer 12 forming the ground plane.

FIG. 7 is a top view of the transition structure 100 of FIG. 4, although here the waveguide block 20 transversally covers and extends somewhat beyond the side edges of the transition arrangement 10. The outer end of the coupling section 3 is located centrally in the double ridged waveguide 21 which also is located such as to partially cover the two of the mushrooms 15,15 which are located closest to the coupling section 3. The waveguide block 20 covers substantially all the mushrooms except for the mushrooms in the distant transversal row which only are covered to a slight extent and two mushrooms in the longitudinal rows farthest away from the coupling section 3. This is however only one particular embodiment and substantially all of the mushrooms may be covered, or fewer mushrooms may be covered, in alternative implementations.

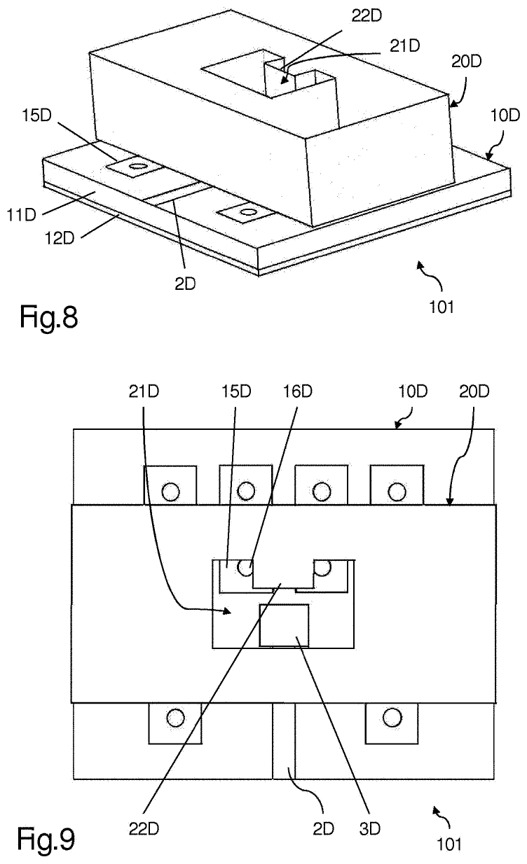

FIG. 8 shows a transition structure 101 comprising a transition arrangement 10 as in FIG. 1, also denoted a planar transition part, and a waveguide block 20D comprising a single ridged waveguide 21D, in an assembled state. The waveguide block 20D is disposed on the transition arrangement 10D such that the single ridged waveguide 21D will be located above the coupling section 3D. In this embodiment the waveguide block 20D covers the mushrooms 15D, . . . except for two mushrooms 15D located in each a longitudinal row and which are most distant with respect to the coupling section (not visible in FIG. 8) and the distant transversal row of mushrooms (not visible in FIG. 8). The EBG structure is also here formed by mushrooms 15D,15D, . . . etched in the substrate 11D and disposed in longitudinal and transversal rows.

The transition structure 101 is similar to the transition structure 100 described with reference to FIGS. 4-7 with the difference that the waveguide is a single ridged waveguide 21D, here with the top of the ridge facing, but being located at a slight distance from, and just above, the coupling section 3D such that a perpendicular microstrip 2D to single ridged waveguide 21D transition is provided. Similar reference numerals as in FIGS. 1,4-7 but indexed “D” are used for corresponding elements which therefore not will be further discussed here.

FIG. 9 is a top view of the transition structure 101 of FIG. 8, although here the waveguide block 20D transversally covers and extends somewhat beyond the side edges of the transition arrangement 10D. The outer free end of the coupling section 3D is located centrally and faces the ridge of the single ridged waveguide 21D, the waveguide block 20D being located such as to partially cover the two mushrooms 15D,15D located closest to the coupling section 3D. The waveguide block 20D covers substantially all the mushrooms except for the mushrooms in the distant transversal row which only are covered to a slight extent and two mushrooms in the longitudinal rows farthest away from the coupling section 3D. This is however only one particular embodiment and also here more or fewer mushrooms may be covered. There may also be more transversal and/or longitudinal rows of mushrooms, for example as disclosed in FIGS. 2,3 or mushrooms arranged in any other appropriate manner, or there may be any other periodic or quasi-periodic structure.

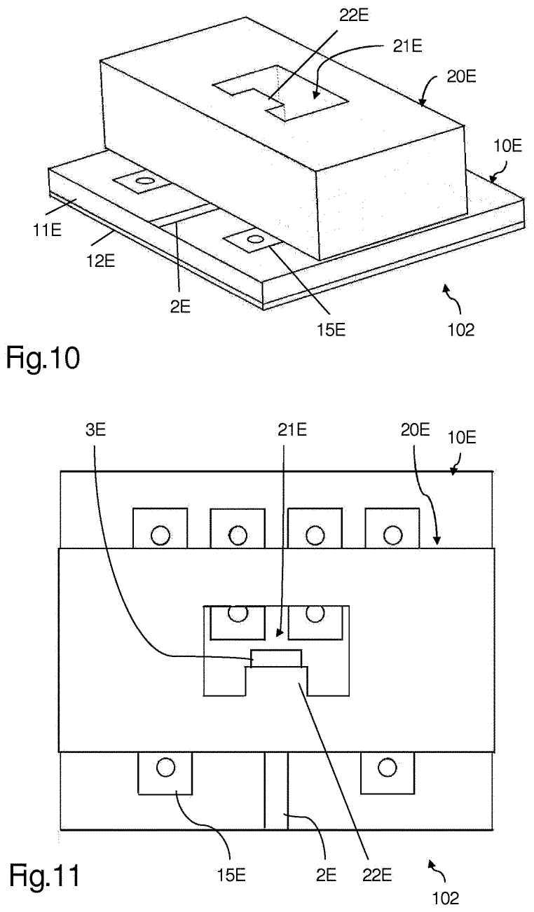

FIG. 10 shows a transition structure 102 comprising a transition arrangement 10E e.g. as in FIG. 1, also denoted a planar transition part, and a waveguide block 20E comprising a single ridged waveguide 21E in an assembled state. The waveguide block 20E is disposed on the transition arrangement 10E such that the single ridged waveguide 21E will be located above the coupling section 3E. Also in this embodiment the waveguide block 20E covers the mushrooms 15E, . . . except for two mushrooms 15E located in each a longitudinal row and which are most distant with respect to the coupling section (not visible in FIG. 10) and the distant transversal row of mushrooms (also not visible in FIG. 10). The EBG structure here formed by mushrooms 15E,15E, . . . etched in the substrate 11E and disposed in longitudinal and transversal rows and stops propagation of waves as discussed above and a contactless transition 102 similar to the transition structure 101 described with reference to FIGS. 8,9 with the difference that the single ridged waveguide 21E is so disposed that the top of the ridge 22E is located above and in parallel with the microstrip 2E ending halfway the extension of the coupling section 3E in the direction of the longitudinal extension of the microstrip 2E, i.e. the ridge of the single ridged waveguide 20E is oppositely directed compared to the ridge of the single ridged waveguide 22D of the structure 101 shown in FIGS. 8,9 such that an alternative perpendicular microstrip to single ridged waveguide transition is provided. However, the electrical performance of the different embodiments are almost the same.

FIG. 11 is a top view of the transition structure 102 of FIG. 10, although also here the waveguide block 20E transversally covers and extends somewhat beyond the side edges of the transition arrangement 10E. The outer free end of the coupling section 3E is located centrally and is disposed in parallel with the ridge of the single ridged waveguide 21E, the waveguide block 20E partially covering the two mushrooms 15E,15E located closest to the coupling section 3E. The waveguide block 20E covers substantially all the mushrooms except for the mushrooms in the distant transversal row which only are covered to a slight extent and two mushrooms in the longitudinal rows farthest away from the coupling section 3E as in the preceding embodiments more or fewer mushrooms may be covered. There may also be more transversal and/or longitudinal rows of mushrooms, for example as disclosed in FIGS. 2, 3 or mushrooms arranged in any other appropriate manner or any other periodic or quasi-periodic structure.

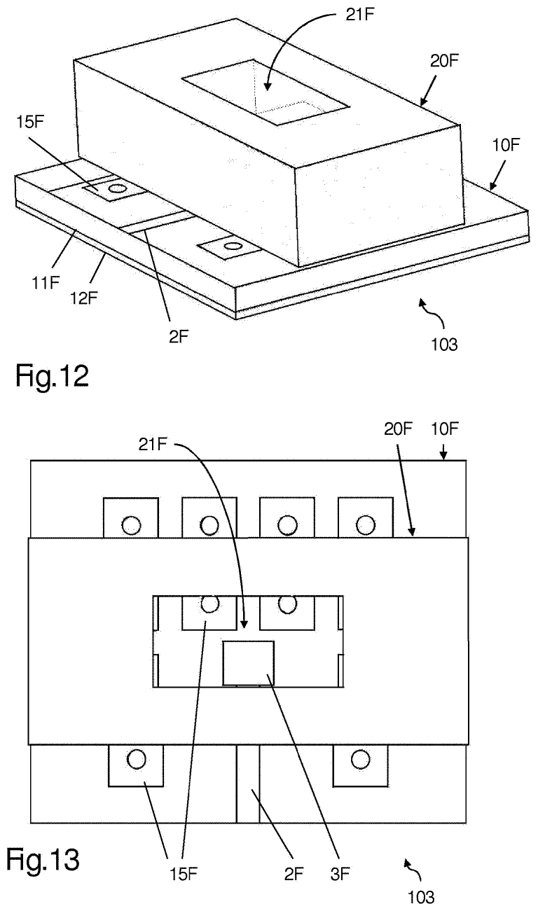

FIG. 12 shows a transition structure 103 comprising a transition arrangement 10F, here substantially as disclosed in FIG. 1 and denoted a planar transition part, and a waveguide block 20F comprising a rectangular waveguide 21F, in an assembled state. It should be clear, however, that with advantage a transition arrangement as in FIG. 2, or a transition arrangement with even one or more additional rows of mushrooms can be used since the aperture of a rectangular waveguide is large. In some implementations, for a transition to a rectangular waveguide, a backshort may be used, but is not needed. Similar reference numerals as in FIGS. 1,4-7 but indexed “F” are used for corresponding elements which therefore not will be further discussed here.

The waveguide block 20F is disposed on the transition arrangement 10F such that the rectangular waveguide 21F will be located above the coupling section 3F. In the shown embodiment the waveguide block 20f covers the mushrooms 15F, . . . except for two mushrooms 15F located in each a longitudinal row and which are most distant with respect to the coupling section (not visible in FIG. 12) and the distant transversal row of mushrooms (not seen in FIG. 12). As in the preceding embodiments the EBG structure is here formed by mushrooms 15F,15F, . . . etched in the substrate 11F and disposed in longitudinal and transversal rows. It should however be clear that also for transitions to rectangular waveguides the EBG structure may be substituted for any other appropriate periodic or quasi-periodic structure, or the mushrooms may have any other appropriate shape and, also, there are preferably more periodic elements such as mushrooms, at least such that the EBG structure will comprise longitudinal rows of mushrooms or similar in, at least in the region of the coupling section 3F, i.e. the EBG structure be wider. In other respects the transition structure 103 is similar to the transition structures described with reference to FIGS. 4-11 with the difference that the waveguide is a rectangular waveguide 21F, and the EBG structure is advantageously adapted thereto, e.g. at least wider, as discussed above.

FIG. 13 is a top view of the transition structure 103 of FIG. 12, but also here the waveguide block 20F transversally covers and extends somewhat beyond the side edges of the transition arrangement 10F, which, as in the preceding embodiments is not necessary for the functioning of the inventive concept; it may be narrower as well as broader. The outer free end of the coupling section 3F is located in the rectangular waveguide 21F opening, the proximal end of it being located substantially at the edge of the waveguide opening and the distant edge being located substantially in the central part of the waveguide opening. The waveguide block 20F is here located such as to partly cover the two mushrooms 15F,15F located closest to the coupling section 3F. The waveguide block 20F also covers at least the major part of substantially all the mushrooms except for the mushrooms in the distant transversal row which only are covered to a slight extent and two mushrooms in the longitudinal rows farthest away from the coupling section 3F. This is however only one particular embodiment and more or fewer, mushrooms may be covered. There are preferably also at least two, or preferably at least four, more longitudinal rows of mushrooms, for example as disclosed in FIGS. 2, 3, and optionally also transversally for performance reasons. The mushrooms may also be disposed in any other appropriate manner or any other periodic or quasi-periodic structure having similar properties may be used.

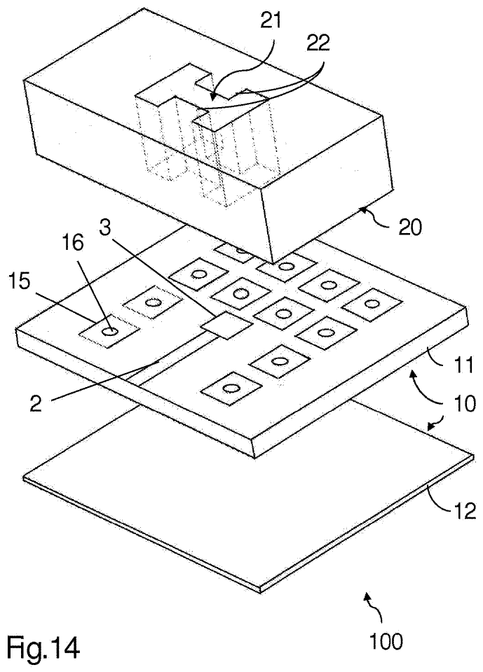

FIG. 14 is a view in perspective of the transition structure 10 of FIG. 4 in a non-assembled state also before interconnection of the conducting layer 12 and the dielectric substrate layer 11 with the etched EBG structure comprising mushrooms 15 and the microstrip 2 with the coupling section 3 forming the transition arrangement 10. The waveguide block 20 with a double ridged waveguide 21 is to be disposed on the transition arrangement 10 for forming a contactless perpendicular microstrip to waveguide transition.

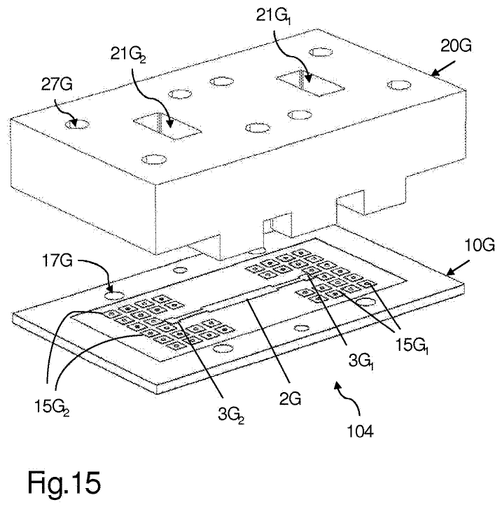

FIG. 15 shows a transition structure 104 comprising two transition arrangements 10G e.g. as in FIG. 1, also denoted a planar transition part, and a waveguide block 20G, here comprising two rectangular waveguides 21G₁,21G₂ in a waveguide block 20G, in a non-assembled state.

Each waveguide 21G₁,21G₂ will be located above a respective coupling section 3G₁,3G₂ and such that there is slight a gap there between, the width of the gap being approximately between 0 to 0.03λ (0-300 μm at 30 GHz). In this embodiment the waveguide block 20G covers a transition part 10G comprising a substrate disposed on a conducting layer as discussed above, and comprising the two transition arrangements comprising a common microstrip 2G at the opposite ends of which a respective coupling section 3G₁,3G₂ is provided, each surrounded by mushrooms 15G₁,15G₂ disposed in as discussed above with respect to the respective coupling section and the microstrip 2G. In other respects the respective elements are disposed and serve corresponding purposes as already discussed above with respect to the other exemplified transition structures 100-102.

Alignment means (not shown) for introduction into alignment holes 27G,17G of any desired type may be used for assuring an appropriate alignment between the waveguide part 20G and the transition part 10G with the two transition arrangements.

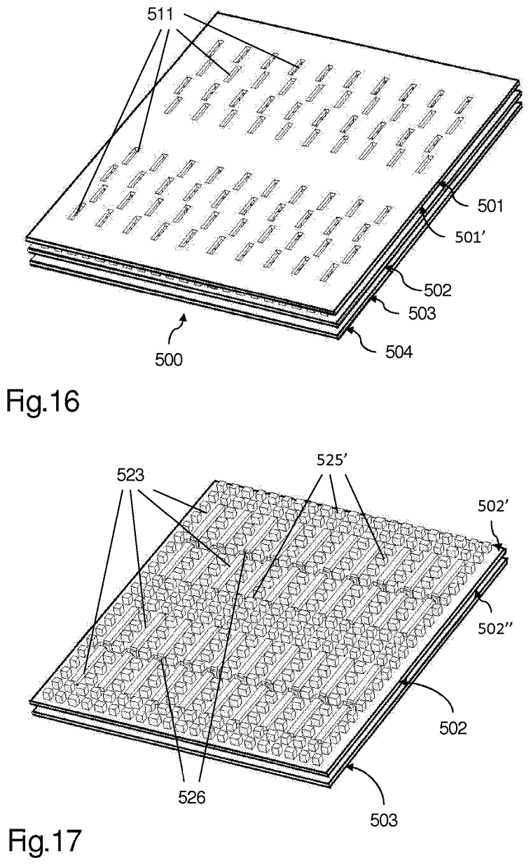

FIG. 16 is a view in perspective of a packaged structure comprising a transmitting and receiving antenna arrangement 500 comprising a number of radiating elements integrated with an RF electronic circuit on circuit layer 503 by means of transition arrangements 510 (see also FIG. 19). The antenna shown here is a slotted ridge gap waveguide comprising two distinct metal layers without any electrical contact requirement between them, e.g. a slot layer or top antenna element layer 501 and a feeding or transmission line layer 502. The top metal slot layer 501 comprises a plurality of radiating elements comprising radiating slots 511, which e.g. are milled. Each transmitting and receiving antenna here consists of ten columns of radiating slots 511 with four slots. The first group of ten columns of slots here is adapted to form a transmitting part Tx, whereas the second group of columns is adapted to form a receiving part Rx (see FIG. 19). FIG. 15 shows a steerable beam solution with two Rx and Tx modules, comprising antenna, circuit, and packaging in one package in a multi-layer architecture.

The top slot layer 501 is disposed on a second layer comprising a ridge gap waveguide feeding layer 502, here provided with a respective pin structure 525′, 525″ on the upper and lower sides respectively, which is advantageous for assembly and packaging purposes e.g. as described in WO2010/003808, “Waveguides and transmission lines in gaps between parallel conducting surfaces”, by the same applicant as the present application, designed for stopping or preventing propagation of waves between the metal layers in other directions than along the waveguiding direction. The dimensions of, and the spacing between the pins, or more generally a periodic or quasi-periodic pattern, depend on for which frequency band the integrated packaged structure is designed. It is e.g. possible to use full height pins or similar on one surface of two opposing surfaces, or half-height pins on two opposing one another facing surfaces such that the total pin height is such as to form a desired stop band.

It should be clear that an antenna arrangement comprising a plurality of contactless microstrip to waveguide transitions according to the inventive concept also is applicable for other antenna and packaging techniques, but then absorbers or similar will be needed and the packaging structure will not be so compact, the compactness of an arrangement as shown in e.g. FIG. 15 and being claimed in this application being extremely advantageous.

Alignment means (not shown) of any desired type may be used for assuring an appropriate alignment of the different layers with respect to one another when assembled.

It should also be clear that the use of other types of antennas also is possible, such as SIW antennas and microstrip antennas, and such implementations are also covered by the inventive concept.

FIG. 17 shows the upper side 502′ of the feeding layer 502 comprising a high impedance surface comprising a plurality of protruding elements, here pins 522′, arranged to form a periodic or quasi-periodic structure and the ridges 523 feed the four slots on the upper slot layer 501.

The high impedance surface in one embodiment comprises pins 525′ with a cross section e.g. having the dimensions of about 0.1λ-0.2λ, in advantageous embodiments about 0.15λ×0.15λ, and a height of 0.15λ-0.3λ, e.g. about 0.2λ. Preferably the pin period is smaller than λ/3, although it may be smaller and larger as well. As an example the pins may have a width of about 1.5 mm, the distance between pins may be about 1.5 mm, and the periodicity may be about 3 mm at 30 GHz. It should be clear that these figures are merely given for illustrative purposes, the figures may be larger as well as smaller, and also the relationships between the dimensions may be different.

It should be clear that the invention is not limited to any particular number or number of rows of pins; it can be more as well as fewer rows, and the high impedance surface can be provided for in many different manners, comprising different number of protrusions with different periodicity and dimensions etc. as also discussed above, and also depending on the frequency band of interest.

The gap between the high impedance surface of the feeding layer 502 and the slot layer 501 e.g. is in the order of size of 250 μm at 30 GHz. It should be clear that also this figure merely is given for illustrative and by no means limitative purposes.

The high impedance surface or the AMC surface which here comprises a periodic or a quasi-periodic pin structure with a plurality of pins 525′ of metal which are arranged to form a bed of pins, is located at a slight distance, a gap, which is smaller, or much smaller, than λ_{g}/4, from the antenna layer, e.g. at a distance of approximately λ_{g}/10. The pins of the periodic or quasi-periodic structure have dimensions and are arranged such as to be adapted for a specific, selected, frequency band, and to block all other waveguide modes.

The non-propagating or non-leaking characteristics between two surfaces of which one is provided with a periodic texture (structure), are e.g. described in P.-S. Kildal, E. Alfonso, A. Valero-Nogueira, E. Rajo-Iglesias, “Local metamaterial-based waveguides in gaps between parallel metal plates”, IEEE Antennas and Wireless Propagation letters (AWPL), Volume 8, pp. 84-87, 2009 and several later publications by these authors. The non-propagating characteristic appears within a specific frequency band, referred to as a stopband. Therefore, the periodic texture must be designed to give a stopband that covers with the operating frequency band. It is also known that such stopbands can be provided by other types of periodic structures, as described in E. Rajo-Iglesias, P.-S. Kildal, “Numerical studies of bandwidth of parallel plate cut-off realized by bed of nails, corrugations and mushroom-type EBG for use in gap waveguides”, IET Microwaves, Antennas & Propagation, Vol. 5, No pp. 282-289, March 2011. According to this document the layers must not be separated more than a quarter of a wavelength of a transmitted signal, or rather have to be separated less than a quarter wavelength. These stopband characteristics are also used to form so called gap waveguides as described in “Waveguides and transmission lines in gaps between parallel conducting surfaces”, PCT/EP2009/057743 by the same applicant as the present invention.

The high impedance surface, e.g. the periodic or quasi-periodic structure comprising pins 525′ may be provided for in many different manners. In one embodiment pins are glued onto the feeding layer. Alternatively pins may be soldered onto the feeding layer. Still further a high impedance surface may be provided through milling and comprise pins, ridges, corrugations or other similar elements forming a periodic or quasi-periodic structure. The pins or similar may of course also have other cross-sectional shapes than square shaped; rectangular, circular etc. The width, or cross-sectional dimension/the height of the pins, corrugations or other elements of any appropriate kind, is determined by the desired operating frequency band.

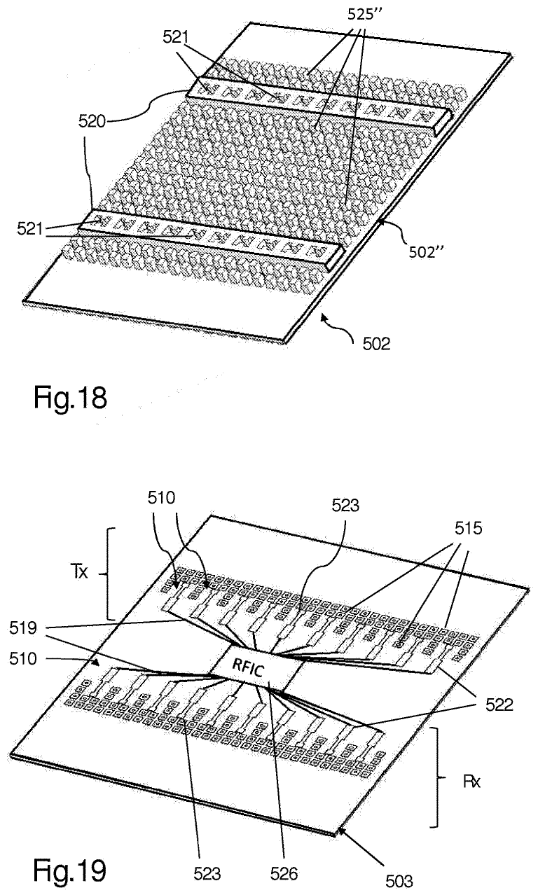

FIG. 18 is a view in perspective showing the opposite (here bottom) side 502″ of the feeding layer 502 adapted to be disposed on the third layer 503, the circuit layer, comprising a plurality of transition arrangements 510 (see FIG. 19) and as described with reference to e.g. FIGS. 4-7 of the present application. The second or bottom side 502′ of the transition layer comprises a plurality of double ridged waveguides 521 disposed in two parallel rows in each a waveguide block 520, one comprising ten (here; it could be fewer as well as more) double ridged waveguides 521 for the transmitting part and the other row comprising ten (here; it could be fewer as well as more) double ridged waveguides 521 for the receiving part of the antenna arrangement 500.

When the second, here bottom, side 502″ of the feeding layer 502 is disposed on the substrate layer 503 comprising a plurality of transition arrangements 510, contactless, perpendicular microstrip to double ridged waveguides 521 transitions will be provided, each corresponding to a transition structure as described with reference to FIGS. 4-7 above, with the difference that each waveguide block 520 comprises ten (here; as mentioned above it should be clear that there could be any number of waveguides, and also other types of waveguides as referred to earlier in the application) waveguides in a row.

The bottom side 502″ of the feeding layer 502 can be used for thermal cooling of active components, such as PAs (power amplifier), which may be mounted on the circuit layer 503.

FIG. 19 shows the circuit layer 503 with two rows of each ten microstrips 522 and a plurality of mushrooms 515 forming respective EBG structures arranged e.g. as disclosed with reference to FIG. 1 along and beyond a respective coupling part 523 of a microstrip 522. In the ends opposite to the coupling sections 523, each microstrip 522 is connected to a circuit 550, e.g. an RFIC or any other passive or active circuit, e.g. an MMIC via channels 519. The circuit layer 503 is disposed on conducting layer 504 forming a ground plane as illustrated in FIG. 19 and as also discussed with reference e.g. to FIG. 1 and which therefore not will be further discussed here. Particularly many different circuit arrangements, in principle any kind of circuit arrangements, e.g. a high (RF) frequency circuit arrangements, MMICs or any other circuit arrangement, e.g. wherein one or several MMICs or hybrid circuits are connected, or mounted on the substrate, MMICs, PCBs of different sizes, active or passive, and it is not limited to any specific frequencies, but is of particular advantage for high frequencies, above 60-70 GHz or more, but also useful for frequencies down to about 25-30 GHz, or even lower.

Through the transition arrangements forming perpendicular transitions to, here, double ridge waveguides, according to the present invention it becomes possible to arrange microstrips, and antenna elements, with element spacing about λ/2, wherein λ is the operating frequency, which is extremely advantageous.

Through the present invention a package comprising an antenna arrangement and a number of active components and with a steerable beam capability is provided which is extremely advantageous.

It is also an advantage that an extremely compact arrangement is provided which, in addition, is extremely easy to assemble, requiring no post processing, and to fabricate, and which preferably can be disassembled.

It is also an advantage that a very compact multiport antenna arrangement can be provided which has a good steerability and which at the same time has a high gain also with a narrow beam with an efficient coupling of energy to the antenna elements via the feeding layer.

As opposed to known antenna arrangements using patches as radiating elements, integrated in a PCB, and comprising but one layer with high losses from the substrate, in media and conductive lines, with a low efficiency, or if a SIW (Surface Integrated Waveguides) are used, still involving losses in the substrate, through the inventive concept, a low loss multilayer structure is provided which has considerably lower losses, with a high efficiency, higher gain and a narrower, steerable beam. Since known arrangements require a distance close to one X. (corresponding to the operating frequency) between adjacent antenna elements, those solutions are not suitable for steering the beam due to high grating lobes, whereas through the inventive concept a distance of about λ/2, e.g. 0.5-0.6λ, or even less or somewhat longer can be used and hence a good steerability is enabled, e.g. up to +/−50°. With the structure according to the invention, it is possible to have many transitions and antennas arranged closely, and a multilayer structure is provided. The arrangement also has a narrow beam and a high gain; in known arrangements a narrow beam leads to a drastic loss in gain. The arrangement further is frequency scalable and can be used for different frequency bands.

It is also an advantage that an arrangement is provided which can be disassembled, reassembled, tested and parts, circuits or layers be exchanged. Through the invention transitions from a circuit arrangement, e.g. an RFIC can be provided to a transmitting part, and also to a receiving part.

The height of a packaging arrangement as described above is less than 7 mm at 30 GHz, and the height of a transition arrangement as in FIG. 1 is less than 2 mm at 30 GHz. The size of the packaged antenna and circuit is depend on the number of antenna element and the required gain and there is no limitation for the total size of the packaged solution.

It should be clear that also antenna elements comprising horns, patches, etc. can be used with the inventive concept, but it is less advantageous, active antenna elements comprising slots in a metal layer being preferred.

For performance measurements a back-to-back structure with two waveguide ports similar to the structure described with reference to FIG. 15 above can be used.

The inventive concept can be implemented for many different applications within wireless communication, e.g. for radar sensors in vehicles, automotive radar, cars, air planes satellites, WiGig (Wireless Gigabit), Wi-Fi, and transition arrangements, transition structures and packaging structures based on the inventive concept are suitable for mass production, and can be used within the microwave and millimeter wave frequency bands, e.g. for operation frequencies from 1 or 3 GHz to about 300 GHz.

It should be clear that the invention is not limited to the specifically illustrated embodiments, but that it can be varied in a number of ways within the scope of the appended claims. The invention is also not limited to any specific circuitry, and supporting electronics is not shown for reasons of clarity and since it does not form part of the main inventive concept.

1. A transition arrangement comprising a first transmission line being a planar transmission line comprising a coupling section and being disposed on a dielectric substrate layer,
wherein the substrate layer comprises or is provided with a periodic or quasi-periodic structure arranged in the substrate layer such as to be disposed along at least part of the first transmission line and to partly surround the coupling section,
wherein the arrangement further comprises a conducting layer on which the substrate layer is arranged and which is adapted to act as a ground plane, and
wherein the periodic or quasi-periodic structure being, or comprising, elements at least some of which being so arranged and having such shapes and/or dimensions, and being located at such a distance from first transmission line and/or the coupling section that EM energy, RF power, can be coupled between the first transmission line and the periodic or quasi-periodic structure, the transition between the coupling section and the periodic or quasi-periodic structure being planar and contactless without any galvanic contact.

2. A transition arrangement according to claim 1, wherein the periodic or quasi-periodic structure comprise periodically or quasi-periodically disposed elements etched in the substrate layer.

3. A transition arrangement according to claim 1, wherein the elements of the periodic or quasi-periodic structure comprise mushrooms or similar,
wherein the mushrooms comprise thin, flat elements with a square shaped,
rectangular, circular, elliptic or any other appropriate cross-sectional shape, disposed in an upper portion of the substrate layer and
wherein the comprise via holes going through the substrate layer to the conducting layer.

4. A transition arrangement according to claim 1, wherein the EBG structure or the periodic or quasi-periodic structure comprise periodically or quasi-periodically disposed elements and wherein the periodically or quasi-periodically disposed elements are so arranged that the elements most close to the coupling section are disposed at a slight distance from the coupling section in the longitudinal direction of the first transmission line, on the opposite side to the location where the coupling section is close to the first transmission line, said distance scalably depending on the wavelength at the operating frequency.

5. A transition arrangement according to claim 3, wherein the elements of the EBG structure or the periodic or quasi-periodic structure are arranged at a distance from each other, or have a periodicity, which preferably at least somewhat exceeds the distance between the coupling section and the closest elements of the periodic or quasi-periodic structure, and, the size of the elements, and the distance between the elements being scalable.

6. A transition arrangement according to claim 1, wherein the periodically or quasi-periodically arranged elements forming the EBG structure, are arranged in transversal and longitudinal rows extending transversally to the extension of the first transmission line and longitudinally on either side along part of the first transmission line, at least in the region where it is close to the coupling section, respectively.

7. A transition arrangement according to claim 6, wherein it comprises at least one, first, transversal row, said first row including the elements disposed closest to the coupling section.

8. A transition arrangement according to claim 7, wherein it comprises two or more transversal rows being arranged substantially in parallel to said first row, further away from the coupling section.

9. A transition arrangement according to claim 8, wherein it comprises two or more longitudinal rows so disposed that said longitudinal rows are disposed symmetrically on each side of and in parallel to the first transmission line.

10. A transition arrangement according to claim 8, wherein it comprises two or more longitudinal rows disposed on each side of the first transmission line.

11. A transition arrangement according to claim 1, wherein the first transmission line comprises a microstrip or a coplanar waveguide.

12. A transition arrangement according to claim 1, wherein the coupling section is adapted to couple the EM-field from the first transmission line to, at least via the closest elements of the periodic or quasi-periodic structure, to a second transmission line, and wherein the elements forming the EBG structure are disposed with respect to one another and have dimensions adapted for a specific, selected, frequency band, blocking all other modes.

13. A transition arrangement according to claim 1, wherein it comprises a high frequency transition arrangement.

14. A transition structure for providing a transition between a first transmission line being a planar transmission line with a coupling section provided on a dielectric substrate layer and a second transmission line comprising a waveguide,
wherein the substrate layer comprises or is provided with a periodic or quasi-periodic structure, disposed along at least part of the first transmission line, and partly surrounding the coupling section, and being disposed on a conducting layer adapted to act as a ground plane, and wherein the periodic or quasi-periodic structure is so arranged and located at such a distance from the coupling section that EM energy, RF power, can be coupled between the first transmission line and the periodic or quasi-periodic structure, and forming a planar transition arrangement wherein the transition between the coupling section and the periodic or quasi-periodic structure is contactless, without any galvanic contact, the substrate layer being adapted for reception of the second transmission line perpendicularly with respect to the planar transition arrangement and at a slight distance therefrom, said distance comprising a gap of less than λ/4, λ being the operating frequency of the transition structure, allowing EM energy, RF power, to be coupled between the first transmission line, via the coupling section and the periodic or quasi-periodic structure of the planar transition arrangement, and the second transmission line.

15. A transition structure according to claim 14, wherein the periodic or quasi-periodic structure comprise periodically or quasi-periodically disposed elements is etched in the substrate layer.

16. A transition structure according to claim 14, wherein the periodic or quasi-periodic structure comprises mushrooms or similar, that the mushrooms comprise thin, flat square shaped, rectangular, circular, elliptic elements or of any other appropriate shape disposed in an upper portion of the substrate layer and wherein it comprises via holes through the substrate layer to the conducting layer.

17. A transition structure according to claim 14, wherein the EBG structure or the periodic or quasi-periodic structure comprises periodically or quasi-periodically disposed elements and wherein the periodically or quasi-periodically disposed elements are so arranged that the elements most close to the coupling section are disposed at a slight distance from the coupling section in the longitudinal direction of the first transmission line, on the opposite side to the location where the coupling section is close to the first transmission line, said distance scalably depending on the wavelength at the operating frequency.

18. A transition structure according to claim 14, wherein the elements of the EBG structure or the periodic or quasi-periodic structure are arranged at a distance from each other, or have a periodicity, which preferably at least somewhat exceeds the distance between the coupling section and the closest elements, the size of the elements being scalable, and the distance between the elements.

19. A transition structure according to claim 14, wherein the periodically or quasi-periodically arranged elements forming the EBG structure, are arranged in transversal and longitudinal rows extending transversally to the extension of the first transmission line and longitudinally on either side along part of the first transmission line, at least in a region where it is close to the coupling section respectively.

20. A transition structure according to claim 14, wherein the first transmission line comprises a microstrip or a coplanar waveguide.

21. A transition structure according to claim 14, wherein the coupling section is adapted to couple the EM-field from the first transmission line to, at least via the closest elements, a second transmission line, and wherein the elements forming the EBG structure or the periodic or quasi-periodic structure are disposed with respect to one another and have dimensions adapted for a specific, selected, frequency band, blocking all other modes.

22. A transition structure according to claim 14, wherein it comprises one or more transversal rows with elements, with a first transversal row including the elements disposed closest to the coupling section, and the other row or rows being arranged substantially in parallel to said first row, further away from the coupling section.

23. A transition structure according to claim 14, wherein it comprises one or more additional transversal element rows arranged substantially in parallel to said first row, further away from the coupling section.

24. A transition structure according to claim 14, wherein it comprises one, or more longitudinal rows with elements so disposed that said longitudinal rows are disposed symmetrically on each side of and in parallel to the first transmission line.

25. A transition structure according to claim 14, wherein the second transmission line comprises a double ridged waveguide.

26. A transition structure according to claim 14, wherein the second transmission line comprises a single ridged waveguide.

27. A transition structure according to claim 14, wherein the second transmission line comprises a rectangular waveguide and wherein the transition structure comprises one or more longitudinal rows of elements, or a transversally wide periodic or quasi-periodic structure.

28. A transition structure according to claim 14, wherein it comprises a high frequency structure.

29. A packaged structure comprising a multi-layered structure with a radiating element layer and a transition layer structure,
wherein the transition layer structure comprises a plurality of transition structures according to claim 14 disposed such as to form a common transition layer structure with transition structure substrate layers adapted to form a common substrate layer on which first transmission lines of the transitions structures are provided such that, for each transition structure the common substrate layer comprises a transition structure substrate layer region comprising or being provided with a periodic or quasi-periodic structure, disposed along at least part of the first transmission line of a respective transition structure and partly surrounding a respective coupling section thereof, and respective transition structure conducting layers adapted to form a common conducting layer acting as a common ground plane of the transition structures, the periodic or quasi-periodic structure regions of the transition structures being so arranged and arranged at such a distance from the respective coupling section that EM energy, RF power, can be coupled between the respective first transmission line and the corresponding periodic or quasi-periodic structure region and comprising planar transition arrangements, wherein each transition between a respective said coupling section and a said periodic or quasi-periodic structure is contactless, without any galvanic contact,
wherein the common transition layer structure further comprises a common transition layer comprising a number of corresponding second transmission lines comprising waveguides the disposed perpendicularly with respect to the corresponding respective planar transition arrangements comprising the first transmission lines allowing EM energy, RF power, to be coupled between each respective first transmission line, via the respective coupling section and the respective periodic or quasi-periodic structure of the planar transition arrangement, and the respective, corresponding second transmission line,
wherein the common transition layer of the common transition layer structure on a side opposite to a side adapted to face the common substrate layer comprises a high impedance or AMC surface, arranged such that there will be a narrow gap between the high impedance or AMC surface region (525) and an opposing surface of the radiating element layer in an assembled state of the packaged structure, which side comprises a plurality of corresponding, for each transition structure, ridge gap waveguides,
wherein the radiating element layer comprises a plurality of radiating elements comprising slot antennas, one for each transition structure and corresponding ridge gap waveguide, and wherein the common substrate layer further comprises one or more circuit arrangements to which the first transmission lines are connected, and wherein adjacent first transmission lines, and corresponding slot antennas in the radiating element layer are located at a distance of about 0.6λ or less from each other respectively, λ being the wavelength at the operating frequency of the transmitting and/or receiving arrangement,
each, transition between a said first transmission line and a said second transmission line being contactless without any galvanic contact between the first transmission line and the second transmission line, and there also being a gap provided between the radiating element layer and the common transition layer structure.

30. A packaged structure according to claim 29,
wherein the distance between adjacent first transmission lines, and between corresponding adjacent slot antennas in the radiating element layer, is about 0.5-0.6λ.

31. A packaged structure according to claim 29,
wherein it comprises a plurality of transition structures with a plurality of waveguide openings provided in respective common waveguide block, each waveguide comprising a contactless transition to a said respective first transmission line and to a corresponding slot antenna, the side comprising a high impedance surface comprising protruding elements to provide a transition structure gap between said side of the common transition layer and the common substrate layer.

32. A packaged structure according to claim 29, wherein the high impedance surface or surfaces of the common transition layer comprises/comprise a periodic or a quasi-periodic structure comprising a pin structure with a plurality of pins, corrugations or similar of metal which are arranged to form a bed of pins, corrugations or similar, the gap being smaller, or much smaller, than λ/4, preferably approximately λ/10, λ being the wavelength in the media surrounding the pins or similar, normally free space or a dielectric media, the pins, corrugations or similar of the periodic or quasi-periodic structure having dimensions adapted for a specific, selected, frequency band, blocking all other modes.

33. A packaged structure according to claim 29, wherein the second transmission lines comprise double-ridged waveguides.

34. A packaged structure according to claim 29, wherein it is a high frequency structure adapted for high frequencies.
